(19) United States
(12) Patent Application Publication
(10) Pub. No.: US 2020/0198306 A1
(43) Pub. Date: Jun. 25, 2020

(54) FLEXIBLE PACKAGING LAMINATION COMPOSITIONS AND FLEXIBLE PACKAGING

(71) Applicant: Flint Group Packaging Inks North America Holdings LLC, Plymouth, MI (US)

(72) Inventors: Huy The Lai, Norwood, OH (US); Robert Alan Garbutt, Maineville, OH (US); Gayle Frances Wirthwine, Fairfield, OH (US)

(73) Assignee: Flint Group Packaging Inks North America Holdings LLC, Plymouth, MI (US)

(21) Appl. No.: 16/230,748

(22) Filed: Dec. 21, 2018

(51) Int. Cl. B32B 27/08; B32B 27/40; B32B 27/36; B32B 27/28

(52) U.S. Cl. CPC B32B 27/08; B32B 27/40; B32B 27/36; B32B 27/283; C08K 5/0016; B32B 2375/00; B32B 2383/00; B32B 2553/00; B32B 2371/00

(57) ABSTRACT

A laminate packaging material has a first film; a first print layer on the first film; a second print layer on the first print layer; an adhesive layer on the second print layer and a second film on the adhesive layer, wherein the second print layer comprises (a) an uncrosslinked polyurethane comprising a member selected from the group consisting of polyester segments and polyether segments; (b) a pigment; and (c) an aminosilane compound comprising at least one member selected from the group consisting of primary amino groups and secondary amino groups.

### FIELD OF THE INVENTION

The present invention relates to printed laminate packaging material and methods for making printed laminate packaging material.

### INTRODUCTION TO THE DISCLOSURE

This section provides information helpful in understanding the invention but that is not necessarily prior art.

Printed laminate films are used in a wide range of flexible packaging applications, including for foods and beverages. Flexible packaging is made with a wide variety of materials, including various plastic films, laminates, and foils that are used to extend the shelf life of and protect package contents. Usually the top film is reverse-printed and subsequently laminated to a similar or dissimilar film. One general arrangement of layers in printed laminate films is that of a first (primary) film layer printed on the inner side, an adhesive applied over the print, and a second (secondary) film layer covering the adhesive. A tertiary film layer can be applied depending on the particular flexible packaging requirements. The primary, secondary and tertiary film layers may be selected from polymer films, papers, or metal foils. The laminate structure improves the appearance and barrier properties of the packaging and may improve its structural integrity as well.

The designs, words, or other printing may be limited to one or a few colors, but it is common for the primary film to be printed with process colors (cyan, yellow, magenta, and black inks) to make a full-color print layer. It is also common to print a final layer of a background color of ink that covers large areas or the whole surface area of the printed side of the primary film, fully covering the prior printed color layer. This background color ink layer, for example a white ink layer (although the background color may be another color in whole or in certain areas), is usually flood coated to provide full coverage of the prior print layer. However, it is quite common to have windows in the package so that one can see the packaged product; in these instances, the white layer may be pattern-coated.

To preserve the appearance and barrier properties during use as a package, the laminate must not split or delaminate between the film layers. However, high lamination bond strength is difficult to achieve when there are multiple print layers in the laminate, for example when a second, background color print layer is applied over a first print layer because the multiple print layers cause delamination to occur at a lower applied force. While not wishing to be bound by theory, the cause of this weakening is believed to be due to disturbance or re-wetting of the first print layer when the background color ink is applied on top of it.

It would thus be desirable to improve the adhesive bond strength of the laminate when multiple print layers are used in making the printed laminate film.

### SUMMARY OF THE DISCLOSURE

This section provides a general summary rather than a comprehensive disclosure of the full scope of our invention and of all its features.

The invention provides a laminate packaging material with improved bond strength that comprises a first film; a first print layer on an inside surface of the first film; a second print layer on a side of the first print layer opposite the first film; and an adhesive layer on a side of the second print layer opposite the first print layer and adjacent to a second film, wherein the second print layer comprises (a) an uncrosslinked polyurethane comprising a member selected from the group consisting of polyester segments and polyether segments; (b) a pigment; and (c) an aminosilane compound comprising at least one member selected from the group consisting of primary amino groups and secondary amino groups. In an embodiment, the first print layer and the second print layer differ in color. In other embodiments, the laminate packaging material includes one or more further print layers, which may be different in color from the first print layer and the second print layer, each such further print layers that lie between the first print layer and the second print layer or between the second print layer and the adhesive layer comprising an uncrosslinked polyurethane (a) which may be the same as the polyurethane (a) in the second print layer, a pigment (b), and an aminosilane compound (c) which may be the same as the aminosilane compound (c) in the second print layer. The second print layer and any further print layers may provide background color(s) for the design and/or text of the first print layer.

The laminate packaging material is prepared by printing a first ink onto a first film to form the first print layer; printing a second ink on at least a portion of the first print layer to form the second print layer; applying an adhesive layer over the second print layer; applying the second film onto the adhesive layer, and laminating all layers together. The second print ink comprises (a) a polyurethane comprising a member selected from the group consisting of polyester segments and polyether segments; (b) a pigment; and (c) an aminosilane compound comprising at least one member selected from the group consisting of primary amino groups and secondary amino groups. A suitable example of an aminosilane compound is N-[3-(trimethoxysilyl)propyl]ethylenediamine. The adhesive layer and second film are preferably coextensive with the first film. The second print layer may cover all or a portion of the first print layer and preferably provides a background color for the first print layer. The second print layer may be coextensive with the first film or may be pattern-coated. In one embodiment, the first print layer has a color other than the color of the second print layer and the second print layer is white or another color or color(s) serving as a background for the first print layer. In an embodiment, the first print layer and the second print layer both comprise the polyurethane (a), but the first print layer is free of the aminosilane compound (c). A further ink may be printed to form a print layer, particularly a second background color print layer, lying at least partially between the first print layer and the second print layer or between the second print layer and the adhesive layer when such further inks comprise the uncrosslinked polyurethane (a) and the aminosilane compound (c).

While not wishing to be bound by theory, it is believed that the composition used to prepare the second print layer according to the invention prevents or reduces re-wetting of the first print layer when the second print layer is printed over the first print layer, leading to the improvement in laminate bond strength.

### DEFINITIONS

In the case of published test methods, such as ASTM methods, the published test methods cited throughout this document refer the version in effect on the date of filing, whether or not the version number is provided, unless specifically noted otherwise. Molecular weights are determined by gel permeation chromatography using a polystyrene calibration curve.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range.

The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. As used in this specification, the term “or” includes any and all combinations of one or more of the associated listed items.

Further areas of applicability will become apparent from the description provided herein. It should be understood that the description and specific examples are intended for purposes of illustration only and are not intended to limit the scope of the present disclosure.

### DETAILED DESCRIPTION

A detailed description including exemplary, nonlimiting embodiments follows.

The laminate packaging material of the invention has at least five layers arranged in order of a first film, a first print layer, a second print layer according to the invention, an adhesive layer, and a second film. The first film, or primary film has an inside surface facing the secondary film, and the second film, or secondary film, has an inside surface facing the primary film. This first print layer is applied to the inside surface of the primary film. The first print layer may provide designs, decorations, text, etc. while the second layer provides a background color. The second print layer is applied over the first print layer. The adhesive layer lies between the second print layer and the secondary film and, in general, is coextensive with the primary and secondary films. The second print layer comprises (a) an uncrosslinked polyurethane comprising a member selected from the group consisting of polyester segments and polyether segments; (b) a pigment; and (c) an aminosilane compound comprising at least one member selected from the group consisting of primary amino groups and secondary amino groups. The first print layer comprising a pigment and may comprise an uncrosslinked polyurethane comprising a member selected from the group consisting of polyester segments and polyether segments. Preferably the first print layer is free of an aminosilane compound.

The first print layer typically may cover only a portion of the inside surface of the primary film, and the first print layer may be continuous or discontinuous. For example, the first print layer may form words, letters, symbols, designs, decorations, or other print on the primary film or may form a pattern over all or a portion the primary film. Likewise, the second print layer form a continuous or discontinuous layer, for example may form a continuous coating layer or a patterned coating layer, for example of a background color, with the caveat that at least part of the second print layer overlies at least part of the first print layer.

In one embodiment, the first print layer and the second print layer is printed using a set of process colors that together make a multi-color or full color first print layer.

In one embodiment, the second print layer is a continuous or patterned layer substantially coextensive with the primary film. For example, the second print layer may serve as a background color (e.g., a white background) for text and/or images of the first print layer or of a multi-color or full color image formed by the first print layer and the one or more additional print layers. When the second print layer is a background color layer, the second print layer generally covers all of or most of the first print layer.

The ink compositions forming the print layer of the laminate packaging material may be solvent-based ink compositions suitable for application by flexographic or gravure printing onto the primary film to form the print layers. “Solvent-based” indicates that the compositions are in an organic solvent medium (rather than an aqueous medium). “Organic solvents” are organic compounds that are liquid at 20° C. and 1 atmosphere pressure.

A first ink is printed, or a set of process color first inks are printed, on the primary film to form a first print layer. The first ink (or each ink of the set of first inks) printed to form the first print layer preferably does not comprise an aminosilane compound and generally includes pigment that is different from the pigment of the second ink used to print the second print layer. The first ink may include a polyurethane comprising a member selected from the group consisting of polyester segments and polyether segments, which polyurethane may be the same as or different from the polyurethane of the second ink.

The second ink is printed over all or at least part of the first print layer to form the second print layer. In one embodiment, the second print layer covers all or substantially all of the first print layer and may form a solid-color background, such as a white background, for the first print layer. The second ink or coating composition comprises (a) a polyurethane comprising a member selected from the group consisting of polyester segments and polyether segments; (b) a pigment; and (c) an aminosilane compound comprising at least one member selected from the group consisting of primary amino groups and secondary amino groups. The polyurethane (a) is a film-forming polymer and is not crosslinked in the second print layer.

An adhesive layer is next applied and preferably is coextensive with the first film. Lastly, the second film is applied over the adhesive layer and all layers are laminated together to form the laminate packaging material.

The materials of the primary and second films are not particularly limited, and any packaging material suitable for the application may be used. Examples of suitable packaging material include, without limitation, polyethylene terephthalate (PET) and treated PET, oriented polypropropylene, biaxially oriented polypropylene, polyamides, poly(vinylidene chloride), acrylics, biaxially oriented polyurethanes, and ethylene vinyl acetate copolymers, which may be in the form of film or board, coextruded laminates prepared with layers of these materials, and laminates of polymer films and metal foils such as aluminum, tin and copper foils. Any polymeric substrate may be printed with this method, including sheets of polyethylene, polypropylene, cellulose acetate, cellulose acetate butyrate, polycarbonate, polyamide, PVDC-coated polypropylene, metallized polyethylene terephthalate, metallized polypropylene, coated or uncoated nylon, or polyethylene terephthalate (PET). PET can be, for example, corona treated PET, chemical treated PET, acrylic coated PET, aluminum oxide coated PET, silicone oxide coated PET, or PVDC-coated PET. Film substrates commonly used for lamination are oriented polypropylene and treated polyester films. The thickness of a packaging material may be any thickness desirably used for forming packages for the target contents.

The ink forming the first print layer is not particularly limited so long as it is suited to the application method, e.g., flexographic or gravure printing, and forms a print layer that will adhere to the primary film. In various embodiments, the ink forming the first print layer comprises any film-forming polymer(s) and a pigment. In certain preferred embodiments, the ink forming the first print layer comprises a polyurethane comprising a member selected from the group consisting of polyester segments and polyether segments, which may be the same as the polyurethane of the second print layer. The first print layer is preferably free of an aminosilane compound.

The second print layer is prepared by applying an ink comprising (a) a polyurethane comprising a member selected from the group consisting of polyester segments and polyether segments; (b) a pigment; and (c) an aminosilane compound

The polyurethane of the second ink layer is a film-forming polymer. The polyurethane may have a weight average molecular weight in the range from about 10,000 to about 100,000 Daltons. The polyurethane is prepared by reacting a diisocyanate with a diol selected from polyester diols and polyether diols and optionally with a nonpolymeric diol and optionally with a diamine to include urea groups in the polyurethane. In one embodiment, the polyurethane is a poly(urethane/urea) produced by reacting an isocyanate-functional polyurethane prepolymer with a diamine, in which the polyurethane prepolymer is the reaction product of: (a) a diisocyanate component and (b) a diol component comprising a short chain diol having a molecular weight up to about 400 and a polyether diol having a molecular weight from about 500 to about 3,000. The poly(urethane/urea) may have an amine value of from about 3 to about 7. The molar ratio of the diisocyanate groups from the diisocyanate component (a) to the OH equivalents from the diol component (b) may be from about 1.2 to about 1.8. The reaction product of (a) and (b) may have from about 1.3 to about 5.0 wt. % of unreacted isocyanate groups, and the molar ratio of short chain diol to polyether diol may be from about 0.67 to about 1.5. The short chain diol may have a melting point at least 25° C.

The polyurethane or the polyurethane prepolymer of the poly(urethane/urea) is produced by reacting a diol component with a diisocyanate component. The diol component comprises a polyether diol and/or polyester diol and optionally further comprises a short chain diol. The poly(urethane/urea) resin is prepared by reacting the prepolymer with a diamine. As used herein, short chain diols are diols having a molecular weight of up to about 400. The polyether diol or polyester diols may have a number average molecular weight in the range from about 500 to about 5000, preferably from about 300 to about 3000.

In making the prepolymer, the diol component and the diisocyanate component may be reacted in a molar ratio of the isocyanate groups from the diisocyanate component to the OH groups from the diol component of from about 1.2 to about 1.8. In one embodiment the molar ratio of the isocyanate groups from the diisocyanate component to the OH groups from the diol component is from about 1.3 to about 1.8. In another embodiment the molar ratio of the isocyanate groups from the diisocyanate component to the OH groups from the diol component is from about 1.4 to about 1.8. In yet another embodiment the molar ratio of the isocyanate groups from the diisocyanate component to the OH groups from the diol component is from about 1.5 to about 1.8. In another embodiment the molar ratio of the isocyanate groups from the diisocyanate component to the OH groups from the diol component is from about 1.6 to about 1.8.

In various embodiments, the prepolymer reaction product of the diisocyanate component and the diol component has from about 1.3 to about 5.0 wt. % of unreacted isocyanate groups. In one embodiment, the prepolymer has from about 1.3 to about 2.5 wt. % of unreacted isocyanate groups. In another embodiment, the prepolymer has from about 1.3 to about 2.0 wt. % of unreacted isocyanate groups.

The diol component used to make the polyurethane or poly(urethane/urea) optionally comprises one or more short chain diols having a molecular weight of up to about 400 and having a melting point of at least about 25° C. The short chain diols may be selected and apportioned to provide a polyurethane capable of forming a tack-free print film. In various embodiments diol component comprises a short chain diol with a molecular weight from about 75 to about 400 and melting point from about 25° C. to about 200° C. In one embodiment the short chain diol has a molecular weight of from about 75 to about 120 and a melting point of at least 25° C. In another embodiment the short chain diol has a molecular weight of from about 120 to about 160 and a melting point of at least 35° C. In yet another embodiment the short chain diol has a molecular weight of from about 160 to about 400 and a melting point of at least 50° C. In various embodiments, the diol component used to form the film-forming polyurethane or poly(urethane/urea) may include one or more short chain diols selected from the group consisting of 1,6-hexanediol, neopentyl glycol, 1,8 octanediol, 1,9 nonanediol, 1,10 decanediol, and 1,12 octadecanediol. In one embodiment, the short chain diol is 1,6-hexanediol. In another embodiment the diol component comprises 1,8-octanediol. In another embodiment the diol component comprises 1,9-nonanediol. And in yet another embodiment the diol component comprises neopentyl glycol.

Polyether diols useful for making the polyurethane include, but are not limited to, polypropylene glycols, polyethylene glycols, and polytetramethylene glycols. In various embodiments of the invention the polyether diol has a number average molecular weight from about 500 to about 3,000, or from about 1,250 to about 2,750, or from about 1,500 to about 2,500, or from about 1,750 to about 2,250, or from about 1,800 to about 2,200. In particular embodiments of present invention the polyether diol is polypropylene glycol. In various embodiments of the invention the polypropylene glycol has a number average molecular weight from about 500 to about 3,000, or from about 1,250 to about 2,750, or from about 1,500 to about 2,500, or from about 1,750 to about 2,250, or from about 1,800 to about 2,200. In other embodiments the number average molecular weight of the polypropylene glycol is about 500, or about 1000, or about 2000, or about 3000.

In various embodiments, the polyurethane or poly(urethane/urea comprises a polyester diol. In various embodiments of the invention the polyester diol has a number average molecular weight from about 500 to about 6,000, or from about 1,000 to about 5000, or from about 1,500 to about 4000, or from about 1,750 to about 3500, or from about 1,800 to about 3500. Suitable examples of polyester diols include the dihydroxy-functional reaction products of dihydric alcohols and dicarboxylic acids. The corresponding carboxylic acid anhydrides or dicarboxylic acid esters of lower alcohols or mixtures thereof may be used. The dicarboxylic acid component may be aliphatic, cycloaliphatic, aromatic and/or heterocyclic. Specific, nonlimiting examples of suitable dicarboxylic acids include succinic acid, adipic acid, suberic acid, azelaic acid, sebacic acid, phthalic acid, isophthalic acid, trimellitic acid, phthalic acid anhydride, tetrahydrophthalic acid anhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid, dimeric and trimeric fatty acids of unsaturated acids such as oleic acid, and lower alcohol esters thereof, e.g. dimethyl terephthalates and bis-glycol terephthalate. Suitable examples of the dihydric alcohols that may be used to make the polyester diol include ethylene glycol, propylene glycol, butylene glycol, hexanediol, octanediol, neopentyl glycol, cyclohexanedimethanol (1,4-bis-hydroxymethyl-cyclohexane), 2-methyl-1,3-propanediol, 2,2,4-trimethyl-1,3-pentanediol, triethylene glycol, tetraethylene glycol, dipropylene glycol, dibutylene glycol, and combinations of these. Polyesters of lactones, such as ε-caprolactone, or hydroxycarboxylic acids, such as hydroxycaproic acid, may also be used.

The polyether diol and/or polyester diol and optionally a short chain diol are reacted with a diisocyanate to form the polyurethane or the prepolymer of the poly(urethane/urea). The molar ratio of polyether and/or polyester diol to short chain diol may be from about 0.67 to about 1.5, or from about 0.71 to about 1.4, or from about 0.77 to about 1.3, or from about 0.83 to about 1.2, or from about 0.83 to about 1.4, or from about 0.83 to about 1.3, or from about 0.83 to about 1.2, or from about 0.83 to about 1.1, or from about 0.9 to about 1.1, or about 1.

Diisocyanates suitable for use in making the polyurethane or prepolymer for the poly(urethane/urea) include, but not limited to, isophorone diisocyanate (IPDI), methylene bis-4-cyclohexyl isocyanate (H12MDI), cyclohexyl diisocyanate (CHDI), 1,3-bis(1-isocyanato-1-methylethyl)benzene, 1,6-hexamethylene diisocyanate (HDI), and 4,4′-diphenylmethane diisocyanate (MDI), toluene diisocyanate (TDI) isomers. In one embodiment, the diisocyanate is selected from the group consisting of aliphatic diisocyanates. In another embodiment of the diisocyanate is selected from the group consisting of IPDI, MDI, TDI, 1,3-bis(1-isocyanato-1-methylethyl)benzene and any combination thereof. In another embodiment, the diisocyanate is selected from the group consisting of TDI and IPDI. In another embodiment, the diisocyanate component is, or consists essentially of, IPDI.

To make a poly(urethane/urea) resin, the polyurethane prepolymer is chain extended by reacting it with a difunctional amine. The polyurethane prepolymer may be added to the diamine in an organic solvent at a controlled rate and in the absence of monoamine chain terminators. In one embodiment the rate of addition of the diamine is from about 11 to about 20 wt. % per minute of polyurethane prepolymer. In another embodiment the rate of addition is from about 13 to about 17 wt. % per minute of polyurethane prepolymer. In still another embodiment the rate of addition is from about 14 to about 17 wt. % per minute of polyurethane prepolymer. The amount of diamine equivalents used in the extension reaction is greater than 120% up to about 130% of the equivalents of unreacted isocyanate groups in the prepolymer. In yet another embodiment the extension reaction is carried out with from about 122% to about 130% of diamine based on equivalents of unreacted isocyanate groups in the prepolymer. In another embodiment the extension reaction is carried out with greater than 120% to about 125% of diamine. In another embodiment the extension reaction is carried out with from about 122% to about 125% of diamine based on equivalents of unreacted isocyanate groups in the prepolymer. The ratio of diamine equivalents to unreacted isocyanate groups used in the present invention is selected to provide for a urea content and diamine end groups that facilitate pigment wetting and enhance lamination bonding strengths.

Diamines suitable as monomers in making the film-forming poly(urethane/urea) include, but are not limited to, ethylene diamine (EDA), 1,3-bis(aminomethyl)cyclohexane (1,3-BAC), 4,4′-diamino-dicyclohexylmethane, 3,3′-dimethyl-4,4′-diamino-dicyclohexylmethane (DMDC) and isophorone diamine (IPDA). In one embodiment of the present invention the diamine is selected from the group consisting of EDA, 1,3-BAC, 4,4′-diamino-dicyclohexylmethane, DMDC, IPDA, and any combination thereof. In another embodiment, the diamine is IPDA. In yet another embodiment the diamine is 1,3-BAC.

The polyurethane, which may be a poly(urethane/urea) as just described, may have a weight average molecular weight from about 10,000 to about 100,000 Daltons. In one embodiment the polyurethane has a weight average molecular weight from about 30,000 to about 80,000 Daltons. In another embodiment, the polyurethane has a weight average molecular weight from about 35,000 to about 80,000. In yet another embodiment, the polyurethane has a weight average molecular weight from about 40,000 to about 80,000. When the polyurethane is a poly(urethane/urea) resin, it may have an amine number from about 3 to about 8 mg KOH/g. In one embodiment the ink used to print the second print layer comprises a poly(urethane/urea) resin having an amine value from about 3 to about 7 mg KOH/g. In another embodiment of the ink used to print the second print layer comprises a poly(urethane/urea) resin having an amine value of from about 4 to about 7 mg KOH/g. In yet another embodiment of the ink used to print the second print layer comprises a poly(urethane/urea) resin having an amine value of from about 4 to about 6 mg KOH/g. In still another embodiment the ink used to print the second print layer comprises a poly(urethane/urea) resin having an amine value of about 5 to about 6 mg KOH/g.

The ink used to print the second print layer contains the polyurethane in a film-forming amount. The polyurethane may be from about 70 wt. % to about 99.5 wt. % of the resin portion of the ink, preferably from about 75 wt. % or from about 80 wt. % or from about 85 wt. % up to about 90 wt. % or up to about 92 wt. % or up to about 94 wt. % or up to about 95 wt. % or up to about 96 wt. % or up to about 97 wt. % or up to about 98 wt. % or up to about 99 wt. % of the resin portion of the ink. The remainder of the resin portion of the ink may be selected from resins that aid in dispersing resins or improve application properties of the ink, such as ketone resins, nitrocellulose resins, maleic acid-modified resins, polyvinyl butyral resins, acrylic resins, rosin-based resins, cellulose-based resins, vinyl chloride-vinyl acetate copolymers, alkyd resins, polyamide resins, and so on. Such resins are commercially available for printing inks from a number of sources.

The ink used to print the second print layer also includes an aminosilane compound comprises at least one member selected from the group consisting of primary amino groups and secondary amino groups. The aminosilane compound may have one primary amine group, or the aminosilane compound may have one secondary amine group, or the aminosilane compound may have one each of a primary amine group and a secondary amine group, or the aminosilane compound may have a plurality of primary and/or secondary amine groups. Nonlimiting examples of suitable aminosilane compounds include N[3-(trimethoxysilyl)propyl]ethylenediamine, aminoethyl triethoxy silane, 2-aminoethyl trimethoxy silane, 2-aminoethyl triethoxy silane, 2-aminoethyl tripropoxy silane, 2-aminoethyl tributoxy silane, 1-aminoethyl trimethoxy silane, 1-aminoethyl triethoxy silane, 3-aminopropyl trimethoxy silane, 3-aminopropyl triethoxy silane, 3-aminopropyl tripropoxy silane, 3-aminopropyl tributoxy silane, 3-aminopropyl methyl dimethoxysilane, 3-aminopropyl ethyl dimethoxysilane, 3-aminopropyl-3-aminopropyldiethylethoxysilane ethyl diethoxysilane, 3-aminopropyl methyl dipropoxysilane, 3-aminopropyl ethyl dipropoxysilane, 3-aminopropyl propyl dipropoxysilane, 3-aminopropyl dimethyl methoxysilane, 3-aminopropyl dimethyl ethoxysilane, 3-aminopropyl diethyl ethoxysilane, 3-aminopropyl dimethyl propoxysilane, 3-aminopropyl diethyl propoxysilane, 3-aminopropyl dipropyl propoxysilane, 2-aminopropyl trimethoxy silane, 2-aminopropyl triethoxy silane, 2-aminopropyl tripropoxy silane, 2-aminopropyl tributoxy silane, 1-aminopropyl trimethoxy silane, 1-aminopropyl triethoxy silane, 1-aminopropyl tripropoxy silane, 1-aminopropyl tributoxy silane, N-aminomethyl aminomethyl trimethoxy silane, N-aminomethyl aminomethyl tripropoxy silane, N-aminomethyl-2-aminoethyl trimethoxy silane, N-aminomethyl-2-aminoethyl triethoxy silane, N-aminomethyl-2-aminoethyl tripropoxy silane, N-aminomethyl-3-aminopropyl trimethoxy silane, N-aminomethyl-3-aminopropyl triethoxy silane, N-aminomethyl-3-aminopropyl tripropoxy silane, N-aminomethyl-2-aminopropyl trimethoxy silane, N-aminomethyl-2-aminopropyl triethoxy silane, N-aminomethyl-2-aminopropyl tripropoxy silane, N-aminopropyl trimethoxy silane, N-aminopropyl triethoxy silane, N-(2-aminoethyl)-2-aminoethyl trimethoxy silane, N-(2-aminoethyl)-2-aminoethyl triethoxy silane, N-(2-aminoethyl)-2-aminoethyl tripropoxy silane, N-(2-aminoethyl)-aminoethyl trimethoxy silane, N-(2-aminoethyl)-1-aminoethyl triethoxy silane, N-(2-aminoethyl)-1-aminoethyl tripropoxy silane, N-(2-aminoethyl)-3-aminopropyl tripropoxy silane, N-(3-aminopropyl)-2-aminoethyl trimethoxy silane, N-(3-aminopropyl)-2-aminoethyl triethoxy silane, N-(3-aminopropyl)-2-aminoethyl tripropoxy silane, N-methyl-3-aminopropyl trimethoxy silane, 3-aminopropyl methyl dimethoxy silane, 3-aminopropyl methyl diethoxy silane, N-(2-aminoethyl)-3-aminopropyl methyl dimethoxy silane, N′-(3-trimethoxysilylpropyl)diethylenetriamine, N′-(3-triethoxysilylpropyl)diethylenetriamine, N′-(3-tripropoxysilylpropyl)diethylenetriamine, and combinations thereof.

The ink used to print the second print layer also includes at least one pigment. A pigment dispersion may be prepared by milling a pigment in a dispersion medium, generally including all or part of the resin portion of the ink being made and diluent or solvent, according to known methods. Any pigment or combination of pigments maybe used. Suitable pigments encompass a wide variety of pigments including, but not limited to, organic pigments such as quinacridones, diketopyrrolopyrrols, dipyrrolopyrroles, phthalocyanines, perylenes, azo pigments, and indanthrones, dioxazines such as carbazole violet, isoindolinones, isoindolons, thioindigo reds, and benzimidazolones, azo condensations, metal complex pigments, and inorganic pigments such as carbon blacks, metal oxides such as titanium dioxide, iron oxides of various colors, and zinc oxide. Further examples of pigments that can be used in the present invention include Pigment Yellow 1, Pigment Yellow 3, Pigment Yellow 12, Pigment Yellow 13, Pigment Yellow 14, Pigment Yellow 17, Pigment Yellow 63, Pigment Yellow 65,Pigment Yellow 73, Pigment Yellow 74, Pigment Yellow 75, Pigment Yellow 83, Pigment Yellow 97, Pigment Yellow 98, Pigment Yellow 106, Pigment Yellow 110, Pigment Yellow 114, Pigment Yellow 121, Pigment Yellow 126, Pigment Yellow 127, Pigment Yellow 136, Pigment Yellow 151, Pigment Yellow 155, Pigment Yellow 174, Pigment Yellow 176, Pigment Yellow 180, Pigment 185, Pigment Yellow 188, Pigment Orange 13, Pigment Orange 16, Pigment Orange 34, Pigment Orange 64, Pigment Red 2, Pigment Red 9, Pigment Red 14, Pigment Red 17, Pigment Red 22, Pigment Red 23, Pigment Red 37, Pigment Red 38, Pigment Red 41, Pigment Red 42, Pigment Red 48, Pigment Red 52, Pigment Red 57, Pigment Red 81, Pigment Red 112, Pigment Red 122, Pigment Red 146, Pigment 166, Pigment Red 170, Pigment Red 176, Pigment 184, Pigment Red 185, Pigment Red 202, Pigment Red 208, Pigment Red 210, Pigment Red 220, Pigment Red 238, Pigment Red 242, Pigment Red 254, Pigment 266, Pigment Blue 15, Pigment Blue 15:1, Pigment Blue 15:2, Pigment Blue 15:3, Pigment Blue 15:4, Pigment Green 7, Pigment Green 36, Pigment Violet 19, Pigment Violet 23, Pigment Violet 37, Pigment Black 7, Pigment White 6, Titanium Dioxide, carbon black, and the like.

Suitable solvents in the ink of the present invention include highly active solvents and various combinations thereof. Such solvents include ketones, aromatic hydrocarbons, aliphatic hydrocarbons, esters, alcohols, and the like, depending on the type of printing ink being prepared, i.e., either flexographic or gravure. It is preferred that the solvent be a combination of ester(s) and alcohol(s) in a ratio of about 1:99 to 99:1, preferably about 10:90 to 20:80. The total amount of solvent is generally about 1 to 70%, preferably about 10 to 50%, and most preferably about 20 to 40%.

A pigment dispersion may be prepared by dissolving the poly(urethane/urea) resin and PVB in an organic solvent, and adding pigment under agitation. This is usually accomplished by mixing the required components in a stainless steel vessel which is equipped with a high-speed electric agitator. Non-limiting examples of suitable milling and dispersion equipment include horizontal shot mills, ball mills, bead mills, roller mills, sand mills, and high-speed dispersers. Many different types of materials may be used as grinding media, such as glass, ceramic, zirconium, metal, or plastic. The grinding media can include particles, preferably substantially spherical in shape, e.g., zirconium beads. In the process of mixing, milling, and dispersion, each process is performed with cooling to prevent buildup of heat.

Typical pigment dispersions include from about 5 to about 50 percent by weight, or from about 10 to about 50 percent by weight pigment or from about 15 to about 50 percent by weight pigment; the amount of pigment used is highly dependent on pigment properties such as specific gravity, surface area, and oil absorption, as is well-known in the art.

Suitable ester solvents include, but are not limited, to propyl acetate, ethyl acetate, butyl acetate, isopropyl acetate, propylene glycol monomethyl ether acetate and the like and combinations thereof. It is preferred that the ester solvent is propyl acetate. The ester solvent may be present in an amount of between about 1 wt. % to about 70 wt. %. It is preferred that the ester solvent be present in an amount of between about 10 wt. % to about 40 wt. % and most preferred between about 10 wt. % to about 20 wt. %

Alcohol solvents include, but are not limited to, ethanol, propanol, isopropanol, glycol ethers, 1-ethoxy-2-propanol, propylene glycol n-propyl ether, dipropylene glycol, n-butyl ether, dipropylene glycol ethyl ether, diacetone alcohol, methyl amyl alcohol, diethylene glycol monobutyl ether, propylene glycol methyl ether and the like, and combinations thereof. It is preferred that the alcohol solvent is propanol or ethanol, and most preferred ethanol. The alcohol solvent may be present in an amount of between about 10 wt. % to about 70 wt. %. It is preferred that the alcohol solvent be present in an amount of between about 20 wt. % to about 60 wt. % and more preferred between about 40 wt. % to about 50 wt. %.

The second print layer composition may optionally further include one or more conventional additives and modifying agents such as an adhesion promoter, such as aluminum, titanium, and zirconium chelates; a wax like polyethylene wax, polyethylene oxide wax, polypropylene wax, fatty amides, and silicone; silica, and/or plasticizers, such as phthalates, phosphate esters, citric esters such as acetyl tributyl citrate, sulfonamides, dicarboxylic acid esters such as adipates and cyclohexane dicarboxylic acid diisononyl ester, and so on. The printing ink may also include waxes such as, but not limited to, amide wax, erucamide wax, polypropylene wax, paraffin wax, polyethylene wax, Teflon, carnuba wax and the like. The wax may be a combination of waxes. It is preferred that the wax be a blend of amide and erucamide waxes. The wax, if present, is in an amount of up to about 4 wt. %. When present, it is preferred that the wax be an amount of between about 0.1 wt. % to about 2 wt. %. The printing ink may contain a desired amount of plasticizer to soften the second print layer for better flexibility.

The polyurethane comprising a member selected from the group consisting of polyester segments and polyether segments is not crosslinked in the second print layer.

The inks may be applied to the selected first film by flexographic or rotogravure (direct or indirect) printing to form the first print layer and the second print layer. The second print layer, comprising the aminosilane compound, has noticeably improved lay and opacity, not disrupting or re-wetting the first print layer, and the laminate bond strength is greatly improved compared to a laminate made without the aminosilane compound in the second print layer.

The adhesive layer may be made using a solvent-containing or solventless adhesive, for example two-component polyester-urethane-type, polyether-urethane-type, or epoxy-type adhesives.

The second film is then applied over the adhesive layer. The second substrate may be composed of the same material as the first substrate or it may be different depending on the nature of the end use of the printed laminate. To provide better barrier properties or a longer shelf life of the content in the package, a third film, such as aluminum foil, polyethylene film, or a cast polypropylene layer can be adhered to the outside surface of the second film to provide a sealant layer for the laminate packaging material.

The laminated packaging material can be formed into a package, such as a package to receive contents such as food products, medicines, chocolate and other candy, pet food, and hygroscopic chemicals.

The invention is further described in the following examples. The example is merely illustrative and does not in any way limit the scope of the invention as described and claimed. All parts are parts by weight unless otherwise noted.

### EXAMPLES

Examples of the inventive laminate packaging material and comparative examples of laminate packaging material were prepared using the cyan inks of Preparations A and B and the white inks of Preparations C to P. PRINTPUR HM 414 BAC is a poly(ester-urethane), 30% solids content in ethyl acetate, obtained from Flint Group, Caronno Pertusella, Italy. PRINTCAT 508 is a titanium complex (TiAA)-free adhesion promoter having 65% solids content in isopropanol and ethanol, obtained from Flint Group, Caronno Pertusella, Italy. Santicizer® 141 was obtained from Valtris Specialty Chemicals. CSME-100 was obtained from Chemista Specialty Chemicals, LLC. FILTREZ® 339 was obtained from Lawter, Inc. NeoRez® U-431 was obtained from DSM Coating Resins. Ketonic Resin HK100 was obtained from Aakash Chemicals. Kronos® 2047 is a titanium dioxide pigment obtained from Kronos Worldwide, Inc. Dawn R-5195 is a titanium dioxide pigment obtained from Shandong Dawn Titanium Industry Co. Ltd. Mowital® B16H was obtained from Kuraray America, Inc.

Preparation A. Flexographic Cyan Ink

A flexographic cyan ink was prepared by combining 25.7 parts by weight of a vehicle solution (11.051 parts by weight n-propanol; 1.028 parts by weight propylene glycol monomethyl ether acetate; 11.565 parts by weight PRINTPUR HM 414 BAC; 0.771 parts by weight propylene glycol monopropyl ether; and 1.285 parts by weight Printcat 508); 14.3 parts by weight of a second vehicle solution (8.2797 parts by weight n-propanol; 0.1716 parts by weight propylene glycol monomethyl ether acetate; 1.9305 parts by weight PRINTPUR HM 414 BAC; 0.1287 parts by weight propylene glycol monopropyl ether; 0.2145 parts by weight PRINTCAT 508; 2.86 parts by weight nitrocellulose solution (28% solids in ethanol and isopropanol); and 0.715 parts by weight n-propyl acetate); 30 parts by weight of a first cyan base (26.76 parts by weight ethanol; 3.06 parts by weight n-propyl acetate; 5.88 parts by weight nitrocellulose solution (28% solids in ethanol and isopropanol); and 7.8 parts by weight of a cyan pigment); and 30 parts by weight of a second cyan base (7.5 parts by weight propylene glycol monopropyl ether; 6.3 parts by weight propylene glycol monoethyl ether; 8.1 parts by weight nitrocellulose solution (28% solids in ethanol and isopropanol); 0.3 parts by weight of Santicizer® 141; 0.3 parts by weight CSME 100; and 7.5 parts by weight of a cyan pigment), the pigment being appropriately dispersed to form the flexographic cyan ink.

Preparation B. Gravure Cyan Ink

A gravure cyan ink was prepared by combining 21 parts by weight of n-propyl acetate; 8 parts by weight of FILTREZ® 339; 12 parts by weight of a cyan pigment; 35.2 parts by weight n-propyl acetate; and 23.8 parts by weight NeoRez® U-431, the pigment being appropriately dispersed to form the gravure cyan ink.

Preparation C. Flexographic White Ink Containing No Silane Compound

A flexographic white ink was prepared by combining 22 parts by weight n-propanol, 4 parts by weight n-propyl acetate, 25 parts by weight PRINTPUR BM 414 BAC, 3 parts by weight Mowital® B16H, 30 parts by weight Kronos® 2047, and 15 parts by weight Dawn R-5195, the pigment being appropriately dispersed to form the flexographic white ink.

Preparation D. Flexographic White Ink Containing 1 wt. % N-β-(Aminoethyl)-γ-aminopropyltrimethoxysilane

A flexographic white ink was prepared by combining 99 parts by weight Preparation C with 1 part by weight N-β-(aminoethyl)-γ-aminopropyltrimethoxysilane.

Preparation E. Flexographic White Ink Containing 1 wt. % Glycidoxypropyltrimethoxysilane

A flexographic white ink was prepared by combining 99 parts by weight Preparation C with 1 part by weight glycidoxypropyltrimethoxysilane.

Preparation F. Flexographic White Ink Containing 0.5 wt. % Vinyltrimethoxysilane and 0.5 wt. % Vinyltriethoxysilane

A flexographic white ink was prepared by combining 99 parts by weight Preparation C with 0.5 wt. % vinyltrimethoxysilane and 0.5 wt. % vinyltriethoxysilane.

Preparation G. Flexographic White Ink Containing 0.5 wt. % N-β-(Aminoethyl)-γ-aminopropyltrimethoxysilane

A flexographic white ink was prepared by combining 99.5 parts by weight Preparation C with 0.5 part by weight N-β-(aminoethyl)-γ-aminopropyltrimethoxysilane.

Preparation H. Flexographic White Ink Containing 1.5 wt. % N-β-(Aminoethyl)-γ-aminopropyltrimethoxysilane

A flexographic white ink was prepared by combining 98.5 parts by weight Preparation C with 1.5 parts by weight N-β-(aminoethyl)-γ-aminopropyltrimethoxysilane.

Preparation I. Flexographic White Ink Containing 2 wt. % N-β-(Aminoethyl)-γ-aminopropyltrimethoxysilane

A flexographic white ink was prepared by combining 98 parts by weight Preparation C with 2 parts by weight N-β-(aminoethyl)-γ-aminopropyltrimethoxysilane.

Preparation J. Gravure White Ink Containing No Silane Compound

A gravure white ink was prepared by combining 5 parts by weight ethanol, 6.5 parts by weight n-propanol, 9.4 parts by weight n-propyl acetate, 38.6 parts by weight PRINTPUR HM 414 BAC, 1 part by weight Ketonic Resin HK100, and 38.5 parts by weight Kronos® 2047, the pigment being appropriately dispersed to form the gravure white ink.

Preparation K. Gravure White Ink Containing 1 wt. % N-β-(Aminoethyl)-γ-aminopropyltrimethoxysilane

A gravure white ink was prepared by combining 99 parts by weight Preparation J with 1 part by weight N-β-(aminoethyl)-γ-aminopropyltrimethoxysilane.

Preparation L. Gravure White Ink Containing 1 wt. % Glycidoxypropyltrimethoxysilane

A gravure white ink was prepared by combining 99 parts by weight Preparation J with 1 part by weight glycidoxypropyltrimethoxysilane.

Preparation M. Gravure White Ink Containing 0.5 wt. % Vinyltrimethoxysilane and 0.5 wt. % Vinyltriethoxysilane

A gravure white ink was prepared by combining 99 parts by weight Preparation J with 0.5 wt. % vinyltrimethoxysilane and 0.5 wt. % vinyltriethoxysilane.

Preparation N. Gravure White Ink Containing 0.5 wt. % N-β-(Aminoethyl)-γ-aminopropyltrimethoxysilane

A gravure white ink was prepared by combining 99.5 parts by weight Preparation J with 0.5 part by weight N-β-(aminoethyl)-γ-aminopropyltrimethoxysilane.

Preparation O. Gravure White Ink Containing 1.5 wt. % N-β-(Aminoethyl)-γ-aminopropyltrimethoxysilane

A gravure white ink was prepared by combining 98.5 parts by weight Preparation J with 1.5 parts by weight N-β-(aminoethyl)-γ-aminopropyltrimethoxysilane.

Preparation P. Gravure White Ink Containing 2 wt. % N-β-(Aminoethyl)-γ-aminopropyltrimethoxysilane

A gravure white ink was prepared by combining 98 parts by weight Preparation J with 2 parts by weight N-β-(aminoethyl)-γ-aminopropyltrimethoxysilane.

The inks of Preparations A-P were adjusted to an appropriate viscosity for printing. For gravure printing, the Preparation B gravure cyan ink was adjusted to 31 to 36 seconds on a No. 2 Shell cup and the Preparations J to P gravure white inks were adjusted to 25 to 28 seconds on a No. 2 Shell cup. For flexographic printing, the Preparation A flexographic cyan inks were adjusted to 24 to 28 seconds on a No. 2 EZ Zahn and the Preparations C to I flexographic white inks were adjusted to 25 to 27 seconds on a No. 2 EZ Zahn cup. The gravure application weights were 0.7 to 1.0 pounds/ream for the cyan ink and 1.2 to 2.0 pounds/ream for the white inks. The flexographic application weights were 0.7 to 1.0 pounds/ream for the cyan ink and 1.0 to 2.0 pounds/ream for the white inks.

Examples of the Invention Made with Cyan Inks Preparations A and B and White Ink Preparations D, G through I, K, and N through P; Comparative Examples Made with Cyan Inks Preparations A and B and White Ink Preparations C, E, F, J, L, and M

The examples and comparative examples were tested by printing a primary film using a K Printing Proofer (obtained from RK PrintCoat Instruments Ltd.) with either only a white ink or else one of the cyan inks then one of the white inks, where the inks were applied in a continuous layer on the primary film, applying a layer of adhesive over the final ink layer, and assembling the printed primary film into a laminate with a secondary film, then testing bond strength and mode of failure for the laminate. Tables 1 to 3 provide the white inks and combinations of cyan inks and white inks used for making the laminates that were tested. The tested combinations were: (i) a layer of white ink applied onto the primary film (White Alone; (ii) color ink applied to the primary film first, then white ink applied over the color ink (Color/White); and (v) a first layer of white ink applied to the primary film, then a second layer of white ink applied over the first layer of white ink (Whiter/White). The films and adhesive combinations tested were:

| | | Secondary | | |
|---|---|---|---|---|
| Designation | Primary Film | Film | Tertiary Film | Adhesive |
| Corona | Corona-treated | Polyethylene | | ADCOTE ™ 577/CR |
| PET/PE | polyethylene | | | 87-124 (obtained from |
| | terephthalate | | | The Dow Chemical |
| | | | | Company) |
| Nylon/PE | Nylon | Polyethylene | | ADCOTE ™ 577/CR |
| | | | | 87-124 (obtained from |
| | | | | The Dow Chemical |
| | | | | Company) |
| Acrylic | Acrylic-coated | Aluminum | Polyethylene | ADCOTE ™ 577/CR |
| PET/Foil/PE | polyethylene | Foil | (applied with a | 87-124 (obtained from |
| | terephthalate | | layer of adhesive to | The Dow Chemical |
| | | | the aluminum foil) | Company) |
| Corona | Corona-treated | Aluminum | Polyethylene | Novacote NC-250/70- |
| PET/Foil/PE | polyethylene | Foil | (applied with a | A with co-reactant |
| | terephthalate | | layer of adhesive to | CA-350 (obtained |
| | | | the aluminum foil) | from Coim USA Inc.) |

To make the examples and comparative examples, a primary film (9.75 inches long by 5 inches wide) was affixed to the K Printing Proofer roller with its treated side facing outward. The color and/or white inks were drawn down on the primary film at a speed of 6 to 7 to ensure that the ink was transferred in a consistent manner. A first layer of applied ink was dried with hot air before application of a next layer. After drying the final ink layer, an adhesive layer was applied and briefly dried with hot air in the same manner as the ink layer(s) to remove excess solvent.

The printed primary film was then removed from the K Printing Proofer and applied to the treated side of a secondary film (9.75 inches long by 5 inches wide). Tapes were placed at the beginning and end of the assembled films for quick evaluation of the initial bond strengths. A rubber roller was used to smooth any wrinkles. Then all samples were stacked between two glass plates. The glass plates containing the samples were placed into an oven held at 100° F. and a 20-pound weight was placed on top of the top glass plate. The samples were then allowed to cure for 3 days in the oven before the adhesive bonds were tested.

The bond strength of the prepared laminates were tested with an Instron Model 5963 System ID: 5965R6490 for180 degree-angle bond test (180-degree adhesive peel test) according to the following procedure. A one-inch wide strip was cut from the laminate as the test sample. The test sample was loaded into the Instron bond tester. The bond tester was set to a speed of 12 inches per minute. The test sample was supported with 610 3M tape on both sides, and as the laminate sample separated it was supported in a tee-shape. The bond strength was recorded by average peak bonds for support. The mode of failure was recorded: Decal=ink deal from the primary film and transfers with the adhesive to the secondary film; IS=ink split between the primary film and the secondary film; ND+no ink decal from the primary film (i.e., the failure is in the adhesive layer or at the adhesive layer-secondary film interface).

Table 1 gives bond strengths for Examples of the Invention (E) and Comparative Examples (CE) in which different adhesive weights were used for the adhesive layers.

TABLE 1
EFFECTS OF DIFFERENT SILANES, ADHESIVE WEIGHT,
AND COLOR OF SECOND PRINT LAYER

| | Designation | Ink | Ink | Ad- | Ink | |
|---|---|---|---|---|---|---|
| | for | used | used | hesive | Layer | |
| | Primary & | for | for | Weight | Coating | |
| | Secondary | First | Second | (pounds | Weights | Bond |
| | Films and | Ink | Ink | per | (pounds | Strength |
| | Adhesive | Layer | Layer | ream) | per ream) | (g/in²) |
| CE1 | Corona PET/PE | K | — | 1.2 | 1.2 | 350¹ |
| CE2 | Corona PET/PE | L | — | 1.2 | 1.2 | 320¹ |
| CE3 | Corona PET/PE | M | — | 1.2 | 1.2 | 346¹ |
| CE4 | Corona PET/PE | J | — | 1.2 | 1.2 | 340¹ |
| CE5 | Corona PET/PE | K | — | 1.5 | 1.2 | 355¹ |
| CE6 | Corona PET/PE | L | — | 1.5 | 1.2 | 360¹ |
| CE7 | Corona PET/PE | M | — | 1.5 | 1.2 | 340¹ |
| CE8 | Corona PET/PE | J | — | 1.5 | 1.2 | 345¹ |
| CE9 | Corona PET/PE | K | — | 1.8 | 1.2 | 362¹ |
| CE10 | Corona PET/PE | L | — | 1.8 | 1.2 | 353¹ |
| CE11 | Corona PET/PE | M | — | 1.8 | 1.2 | 347¹ |
| CE12 | Corona PET/PE | J | — | 1.8 | 1.2 | 355¹ |
| E1 | Corona PET/PE | B | K | 1.2 | Cyan-0.7, | 700¹ |
| | | | | | white-1.2 | |
| CE13 | Corona PET/PE | B | L | 1.2 | Cyan-0.7, | 102¹ |
| | | | | | white-1.2 | |
| CE14 | Corona PET/PE | B | M | 1.2 | Cyan-0.7, | 249¹ |
| | | | | | white-1.2 | |
| CE15 | Corona PET/PE | B | J | 1.2 | Cyan-0.7, | 270¹ |
| | | | | | white-1.2 | |
| E2 | Corona PET/PE | B | K | 1.5 | Cyan-0.7, | 600¹ |
| | | | | | white-1.2 | |
| CE16 | Corona PET/PE | B | L | 1.5 | Cyan-0.7, | 87¹ |
| | | | | | white-1.2 | |
| CE17 | Corona PET/PE | B | M | 1.5 | Cyan-0.7, | 210¹ |
| | | | | | white-1.2 | |
| CE18 | Corona PET/PE | B | J | 1.5 | Cyan-0.7, | 275¹ |
| | | | | | white-1.2 | |
| E3 | Corona PET/PE | B | K | 1.8 | Cyan-0.7, | 530¹ |
| | | | | | white-1.2 | |
| CE19 | Corona PET/PE | B | L | 1.8 | Cyan-0.7, | 92¹ |
| | | | | | white-1.2 | |
| CE20 | Corona PET/PE | B | M | 1.8 | Cyan-0.7, | 192¹ |
| | | | | | white-1.2 | |
| CE21 | Corona PET/PE | B | J | 1.8 | Cyan-0.7, | 250¹ |
| | | | | | white-1.2 | |
| CE22 | Nylon/PE | K | — | 1.2 | 1.2 | 720² |
| CE23 | Nylon/PE | L | — | 1.2 | 1.2 | 467² |
| CE24 | Nylon/PE | M | — | 1.2 | 1.2 | 700¹ |
| CE25 | Nylon/PE | J | — | 1.2 | 1.2 | 750¹ |
| CE26 | Nylon/PE | K | — | 1.5 | 1.2 | 640² |
| CE27 | Nylon/PE | L | — | 1.5 | 1.2 | 452¹ |
| CE28 | Nylon/PE | M | — | 1.5 | 1.2 | 711¹ |
| CE29 | Nylon/PE | J | — | 1.5 | 1.2 | 764¹ |
| CE30 | Nylon/PE | K | — | 1.8 | 1.2 | 611² |
| CE31 | Nylon/PE | L | — | 1.8 | 1.2 | 449¹ |
| CE32 | Nylon/PE | M | — | 1.8 | 1.2 | 620¹ |
| CE33 | Nylon/PE | J | — | 1.8 | 1.2 | 649¹ |
| E4 | Nylon/PE | J | K | 1.2 | white-1.2, | 708² |
| | | | | | white-1.2 | |
| CE34 | Nylon/PE | J | L | 1.2 | white-1.2, | 342¹ |
| | | | | | white-1.2 | |
| CE35 | Nylon/PE | J | M | 1.2 | white-1.2, | 299¹ |
| | | | | | white-1.2 | |
| CE36 | Nylon/PE | J | J | 1.2 | white-1.2, | 388¹ |
| | | | | | white-1.2 | |
| E5 | Nylon/PE | J | K | 1.5 | white-1.2, | 545² |
| | | | | | white-1.2 | |
| CE37 | Nylon/PE | J | L | 1.5 | white-1.2, | 377¹ |
| | | | | | white-1.2 | |
| CE38 | Nylon/PE | J | M | 1.5 | white-1.2, | 315¹ |
| | | | | | white-1.2 | |
| CE39 | Nylon/PE | J | J | 1.5 | white-1.2, | 237¹ |
| | | | | | white-1.2 | |
| E6 | Nylon/PE | J | K | 1.8 | white-1.2, | 499² |
| | | | | | white-1.2 | |
| CE40 | Nylon/PE | J | L | 1.8 | white-1.2, | 310¹ |
| | | | | | white-1.2 | |
| CE41 | Nylon/PE | J | M | 1.8 | white-1.2, | 306¹ |
| | | | | | white-1.2 | |
| CE42 | Nylon/PE | J | J | 1.8 | white-1.2, | 146¹ |
| | | | | | white-1.2 | |
| E7 | Nylon/PE | B | K | 1.2 | Cyan-0.7, | 641² |
| | | | | | white-1.2 | |
| CE43 | Nylon/PE | B | L | 1.2 | Cyan-0.7, | 90¹ |
| | | | | | white-1.2 | |
| CE44 | Nylon/PE | B | M | 1.2 | Cyan-0.7, | 97¹ |
| | | | | | white-1.2 | |
| CE45 | Nylon/PE | B | J | 1.2 | Cyan-0.7, | 137¹ |
| | | | | | white-1.2 | |
| E8 | Nylon/PE | B | K | 1.5 | Cyan-0.7, | 620² |
| | | | | | white-1.2 | |
| CE46 | Nylon/PE | B | L | 1.5 | Cyan-0.7, | 72¹ |
| | | | | | white-1.2 | |
| CE47 | Nylon/PE | B | M | 1.5 | Cyan-0.7, | 110¹ |
| | | | | | white-1.2 | |
| CE48 | Nylon/PE | B | J | 1.5 | Cyan-0.7, | 120¹ |
| | | | | | white-1.2 | |
| E9 | Nylon/PE | B | K | 1.8 | Cyan-0.7, | 667² |
| | | | | | white-1.2 | |
| CE49 | Nylon/PE | B | L | 1.8 | Cyan-0.7, | 75¹ |
| | | | | | white-1.2 | |
| CE50 | Nylon/PE | B | M | 1.8 | Cyan-0.7, | 84¹ |
| | | | | | white-1.2 | |
| CE51 | Nylon/PE | B | J | 1.8 | Cyan-0.7, | 93¹ |
| | | | | | white-1.2 | |
| CE52 | Acrylic PET/ | K | — | 1.5 | 1.2 | 682³ |
| | Foil/PE | | | | | |
| CE53 | Acrylic PET/ | L | — | 1.5 | 1.2 | 662³ |
| | Foil/PE | | | | | |
| CE54 | Acrylic PET/ | M | — | 1.5 | 1.2 | 687³ |
| | Foil/PE | | | | | |
| CE55 | Acrylic PET/ | J | — | 1.5 | 1.2 | 731³ |
| | Foil/PE | | | | | |
| CE56 | Acrylic PET/ | K | — | 2.0 | 1.2 | 650³ |
| | Foil/PE | | | | | |
| CE57 | Acrylic PET/ | L | — | 2.0 | 1.2 | 650³ |
| | Foil/PE | | | | | |
| CE58 | Acrylic PET/ | M | — | 2.0 | 1.2 | 639³ |
| | Foil/PE | | | | | |
| CE59 | Acrylic PET/ | J | — | 2.0 | 1.2 | 680³ |
| | Foil/PE | | | | | |
| CE60 | Acrylic PET/ | K | — | 2.5 | 1.2 | 589³ |
| | Foil/PE | | | | | |
| CE61 | Acrylic PET/ | L | — | 2.5 | 1.2 | 644³ |
| | Foil/PE | | | | | |
| CE62 | Acrylic PET/ | M | — | 2.5 | 1.2 | 540³ |
| | Foil/PE | | | | | |
| CE63 | Acrylic PET/ | J | — | 2.5 | 1.2 | 610³ |
| | Foil/PE | | | | | |
| E10 | Acrylic PET/ | B | K | 1.5 | Cyan-0.7, | 878² |
| | Foil/PE | | | | white-1.2 | |
| CE64 | Acrylic PET/ | B | L | 1.5 | Cyan-0.7, | 110¹ |
| | Foil/PE | | | | white-1.2 | |
| CE65 | Acrylic PET/ | B | M | 1.5 | Cyan-0.7, | 350¹ |
| | Foil/PE | | | | white-1.2 | |
| CE66 | Acrylic PET/ | B | J | 1.5 | Cyan-0.7, | 145¹ |
| | Foil/PE | | | | white-1.2 | |
| E11 | Acrylic PET/ | B | K | 2.0 | Cyan-0.7, | 800² |
| | Foil/PE | | | | white-1.2 | |
| CE67 | Acrylic PET/ | B | L | 2.0 | Cyan-0.7, | 103¹ |
| | Foil/PE | | | | white-1.2 | |
| CE68 | Acrylic PET/ | B | M | 2.0 | Cyan-0.7, | 270¹ |
| | Foil/PE | | | | white-1.2 | |
| CE69 | Acrylic PET/ | B | J | 2.0 | Cyan-0.7, | 78¹ |
| | Foil/PE | | | | white-1.2 | |
| E12 | Acrylic PET/ | B | K | 2.5 | Cyan-0.7, | 812² |
| | Foil/PE | | | | white-1.2 | |
| CE70 | Acrylic PET/ | B | L | 2.5 | Cyan-0.7, | 80¹ |
| | Foil/PE | | | | white-1.2 | |
| CE71 | Acrylic PET/ | B | M | 2.5 | Cyan-0.7, | 233¹ |
| | Foil/PE | | | | white-1.2 | |
| CE72 | Acrylic PET/ | B | J | 2.5 | Cyan-0.7, | 73¹ |
| | Foil/PE | | | | white-1.2 | |
| CE73 | Corona PET/ | D | — | 1.2 | 1.2 | 612³ |
| | Foil/PE | | | | | |
| CE74 | Corona PET/ | E | — | 1.2 | 1.2 | 549³ |
| | Foil/PE | | | | | |
| CE75 | Corona PET/ | F | — | 1.2 | 1.2 | 738³ |
| | Foil/PE | | | | | |
| CE76 | Corona PET/ | C | — | 1.2 | 1.2 | 820³ |
| | Foil/PE | | | | | |
| CE77 | Corona PET/ | D | — | 1.5 | 1.2 | 480³ |
| | Foil/PE | | | | | |
| CE78 | Corona PET/ | E | — | 1.5 | 1.2 | 521³ |
| | Foil/PE | | | | | |
| CE79 | Corona PET/ | F | — | 1.5 | 1.2 | 719³ |
| | Foil/PE | | | | | |
| CE80 | Corona PET/ | C | — | 1.5 | 1.2 | 710³ |
| | Foil/PE | | | | | |
| CE81 | Corona PET/ | D | — | 1.8 | 1.2 | 492³ |
| | Foil/PE | | | | | |
| CE82 | Corona PET/ | E | — | 1.8 | 1.2 | 520³ |
| | Foil/PE | | | | | |
| CE83 | Corona PET/ | F | — | 1.8 | 1.2 | 688³ |
| | Foil/PE | | | | | |
| CE84 | Corona PET/ | C | — | 1.8 | 1.2 | 705³ |
| | Foil/PE | | | | | |
| E13 | Corona PET/ | A | D | 1.2 | Cyan-0.7, | 653² |
| | Foil/PE | | | | white-1.2 | |
| CE85 | Corona PET/ | A | E | 1.2 | Cyan-0.7, | 82¹ |
| | Foil/PE | | | | white-1.2 | |
| CE86 | Corona PET/ | A | F | 1.2 | Cyan-0.7, | 128¹ |
| | Foil/PE | | | | white-1.2 | |
| CE87 | Corona PET/ | A | C | 1.2 | Cyan-0.7, | 118¹ |
| | Foil/PE | | | | white-1.2 | |
| E14 | Corona PET/ | A | D | 1.5 | Cyan-0.7, | 520² |
| | Foil/PE | | | | white-1.2 | |
| CE88 | Corona PET/ | A | E | 1.5 | Cyan-0.7, | 50¹ |
| | Foil/PE | | | | white-1.2 | |
| CE89 | Corona PET/ | A | F | 1.5 | Cyan-0.7, | 153¹ |
| | Foil/PE | | | | white-1.2 | |
| CE90 | Corona PET/ | A | C | 1.5 | Cyan-0.7, | 110¹ |
| | Foil/PE | | | | white-1.2 | |
| E15 | Corona PET/ | A | D | 1.8 | Cyan-0.7, | 519² |
| | Foil/PE | | | | white-1.2 | |
| CE91 | Corona PET/ | A | E | 1.8 | Cyan-0.7, | 45¹ |
| | Foil/PE | | | | white-1.2 | |
| CE92 | Corona PET/ | A | F | 1.8 | Cyan-0.7, | 130¹ |
| | Foil/PE | | | | white-1.2 | |
| CE93 | Corona PET/ | A | C | 1.8 | Cyan-0.7, | 110¹ |
| | Foil/PE | | | | white-1.2 | |

1. Mode of bond failure is decal (failure at the primary film/first ink layer interface)
2. Mode of bond failure is splitting within an ink layer
3. Mode of bond failure is at the last ink layer/adhesive layer interface

The testing results in Table 1 demonstrate the unexpectedly large improvement in laminate bond strength when the second print layer includes (a) an uncrosslinked polyurethane comprising a member selected from the group consisting of polyester segments and polyether segments; (b) a pigment; and (c) an aminosilane compound comprising at least one member selected from the group consisting of primary amino groups and secondary amino groups.

Comparative Examples CE1-CE12, CE22-CE33, CE52-CE63, and CE73-CE84 show the effects on bond strength for a single print layer (the tested print layer was white), for increasing adhesive layer weights (1.2, 1.5, and 1.8 pounds per ream) without any silane compound and with each of three silane-containing print layers tested: a print layer with N-β-(aminoethyl)-γ-aminopropyltrimethoxysilane, a print layer with glycidoxypropyltrimethoxysilane, and a print layer with a mixture of vinyltrimethoxysilane and vinyltriethoxysilane.

Comparative Examples CE1-CE12, the laminates made with corona-treated PET and polyethylene films, showed little change in laminate bond strength between the different adhesive layer weights, between the print layers containing no silane and the print layers containing one of the tested silanes, or between the print layers made with the three different silanes tested. All of the laminates exhibited a decal mode of failure (failure at the primary film-print layer interface).

In Comparative Examples CE22-CE33, the laminates made with the nylon and polyethylene films, the laminate bond strength was significantly reduced with an increase in the adhesive layer weights and, compared to the print layer containing no silane, bond strength was somewhat reduced when the print layer included N-β-(aminoethyl)-γ-aminopropyltrimethoxysilane or a mixture of vinyltrimethoxysilane and vinyltriethoxysilane and bond strength was significantly reduced when the print layer included glycidoxypropyltrimethoxysilane. The laminates made with N-β-(aminoethyl)-γ-aminopropyltrimethoxysilane in the print layer exhibited ink layer splitting failure, while all but one of the remaining laminates had a decal mode of failure.

Comparative Examples CE73-CE84, the laminates made with corona-treated PET, foil, and polyethylene films, also showed significant reduction in bond strength with higher adhesive weights and significant reduction in bond strength with a silane-containing print layer compared to a print layer containing no silane. The mode of bond failure in all of these laminated was at the adhesive layer interface.

Comparative Examples CE52-CE63, the laminates made with acrylic-coated PET, foil, and polyethylene films, showed significant reduction in bond strength in all of the laminates with higher adhesive weights and significant reduction in bond strength in all of the laminates with a silane-containing print layer. The mode of bond failure in all of these laminated was at the last ink layer/adhesive layer interface.

Examples E1-E3 and E7-E15 and Comparative Examples CE13-CE21, CE43-CE51, CE64-CE72, and CE85-CE93 show the effects on bond strength for laminates made with a first, cyan print layer containing no silane and a second, white print layer when the laminate was made with different adhesive layer weights (1.2, 1.5, and 1.8 pounds per ream) and the second white print layer was made with no silane compound or with one of three silanes tested: N-β-(aminoethyl)-γ-aminopropyltrimethoxysilane (the examples of the invention), glycidoxypropyltrimethoxysilane (comparative examples), or a mixture of vinyltrimethoxysilane and vinyltriethoxysilane (comparative examples).

Examples E1-E3 and Comparative Examples CE13-CE21 were laminates made with corona-treated PET and polyethylene films. Comparative Examples CE1-CE12 had only one, white print layer, while Examples E1 to E3, which had a first cyan print layer applied before a white print layer containing the polyurethane and aminosilane compound according to the invention, had much higher bond strengths, up to twice as strong. In contrast, Comparative Examples CE13-CE21 all had significantly lower bond strengths, particularly the comparative examples made with glycidoxypropyltrimethoxysilane and the comparative examples made with a mixture of vinyltrimethoxysilane and vinyltriethoxysilane at higher adhesive layer weights. All of the laminates made with corona-treated PET and polyethylene films exhibited a decal mode of failure.

Examples E7-E9 and Comparative Examples CE43-CE51 were made with the nylon and polyethylene films. The laminates of Examples E7-E9 according to the invention had similar bond strengths to Comparative Examples CE22-CE33, which had only one, white print layer, and continued to have an ink-splitting failure mode while the Comparative Examples CE43-CE51 laminates all had large reductions in bond strength while they continued to have a decal failure mode.

Examples E10-E12 and Comparative Examples CE64-CE72 were made with acrylic-coated PET, foil, and polyethylene films. Examples E13-E15 and Comparative Examples CE85-CE93 were made with corona-treated PET, foil, and polyethylene films. The results from testing these sets of examples were similar to those obtained for the nylon and polyethylene film laminates, with the Examples of the Invention E10-E15 actually showing an increase in bond strength over the comparative examples made with only the one, white print layer, while all the cyan print layer-white layer comparative examples CE64-CE72 and CE85-CE93 had greatly reduced bond strengths.

Finally, Examples of the Invention E4-E6 and Comparative Examples CE34-CE42 tested laminated made with nylon and polyethylene films in which the first print layer was thicker, a white print layer with a coating weight of 1.2 pounds per ream compared to the cyan print layer having 0.7 pounds per ream used in Examples E7-E9 and Comparative Examples CE43-CE51. While overall the bond strengths were higher when the first print layer was white than when the first print layer was cyan, the Examples of the Invention again had substantially higher bond strengths for all adhesive weights tested than did the comparative examples.

Table 2 gives bond strengths for Examples of the Invention (E) and Comparative Examples (CE) in which different coating weights were used for the white ink layers.

TABLE 2
EFFECTS OF DIFFERENT SILANES AND INK PRINT
LAYER WEIGHTS

| | Designation | Ink | Ink | Ad- | Ink | |
|---|---|---|---|---|---|---|
| | for | used | used | hesive | Layer | |
| | Primary & | for | for | Weight | Coating | |
| | Secondary | First | Second | (pounds | Weights | Bond |
| | Films | Ink | Ink | per | (pounds | Strength |
| | and Adhesive | Layer | Layer | ream) | per ream) | (g/in²) |
| CE94 | Corona PET/PE | K | — | 1.2 | 1.0 | 410 |
| CE95 | Corona PET/PE | L | — | 1.2 | 1.0 | 426 |
| CE96 | Corona PET/PE | M | — | 1.2 | 1.0 | 404 |
| CE97 | Corona PET/PE | J | — | 1.2 | 1.0 | 420 |
| CE98 | Corona PET/PE | K | — | 1.2 | 1.5 | 405 |
| CE99 | Corona PET/PE | L | — | 1.2 | 1.5 | 420 |
| CE100 | Corona PET/PE | M | — | 1.2 | 1.5 | 415 |
| CE101 | Corona PET/PE | J | — | 1.2 | 1.5 | 396 |
| CE102 | Corona PET/PE | K | — | 1.2 | 2.0 | 390 |
| CE103 | Corona PET/PE | L | — | 1.2 | 2.0 | 422 |
| CE104 | Corona PET/PE | M | — | 1.2 | 2.0 | 395 |
| CE105 | Corona PET/PE | J | — | 1.2 | 2.0 | 370 |
| E16 | Corona PET/PE | B | K | 1.2 | Cyan-0.7, | 645 |
| | | | | | white-1.0 | |
| CE106 | Corona PET/PE | B | L | 1.2 | Cyan-0.7, | 175 |
| | | | | | white-1.0 | |
| CE107 | Corona PET/PE | B | M | 1.2 | Cyan-0.7, | 243 |
| | | | | | white-1.0 | |
| CE108 | Corona PET/PE | B | J | 1.2 | Cyan-0.7, | 250 |
| | | | | | white-1.0 | |
| E17 | Corona PET/PE | B | K | 1.2 | Cyan-0.7, | 658 |
| | | | | | white-1.5 | |
| CE109 | Corona PET/PE | B | L | 1.2 | Cyan-0.7, | 192 |
| | | | | | white-1.5 | |
| CE110 | Corona PET/PE | B | M | 1.2 | Cyan-0.7, | 220 |
| | | | | | white-1.5 | |
| CE111 | Corona PET/PE | B | J | 1.2 | Cyan-0.7, | 215 |
| | | | | | white-1.5 | |
| E18 | Corona PET/PE | B | K | 1.2 | Cyan-0.7, | 671 |
| | | | | | white-2.0 | |
| CE112 | Corona PET/PE | B | L | 1.2 | Cyan-0.7, | 135 |
| | | | | | white-2.0 | |
| CE113 | Corona PET/PE | B | M | 1.2 | Cyan-0.7, | 216 |
| | | | | | white-2.0 | |
| CE114 | Corona PET/PE | B | J | 1.2 | Cyan-0.7, | 208 |
| | | | | | white-2.0 | |
| CE115 | Nylon/PE | K | — | 1.2 | 1.0 | 800 |
| CE116 | Nylon/PE | L | — | 1.2 | 1.0 | 788 |
| CE117 | Nylon/PE | M | — | 1.2 | 1.0 | 810 |
| CE118 | Nylon/PE | J | — | 1.2 | 1.0 | 821 |
| CE119 | Nylon/PE | K | — | 1.2 | 1.5 | 725 |
| CE120 | Nylon/PE | L | — | 1.2 | 1.5 | 735 |
| CE121 | Nylon/PE | M | — | 1.2 | 1.5 | 717 |
| CE122 | Nylon/PE | J | — | 1.2 | 1.5 | 730 |
| CE123 | Nylon/PE | K | — | 1.2 | 2.0 | 736 |
| CE124 | Nylon/PE | L | — | 1.2 | 2.0 | 680 |
| CE125 | Nylon/PE | M | — | 1.2 | 2.0 | 700 |
| CE126 | Nylon/PE | J | — | 1.2 | 2.0 | 728 |
| E19 | Nylon/PE | B | K | 1.2 | Cyan-0.7, | 780 |
| | | | | | white-1.0 | |
| CE127 | Nylon/PE | B | L | 1.2 | Cyan-0.7, | 94 |
| | | | | | white-1.0 | |
| CE128 | Nylon/PE | B | M | 1.2 | Cyan-0.7, | 120 |
| | | | | | white-1.0 | |
| CE129 | Nylon/PE | B | J | 1.2 | Cyan-0.7, | 150 |
| | | | | | white-1.0 | |
| E20 | Nylon/PE | B | K | 1.2 | Cyan-0.7, | 771 |
| | | | | | white-1.5 | |
| CE130 | Nylon/PE | B | L | 1.2 | Cyan-0.7, | 80 |
| | | | | | white-1.5 | |
| CE131 | Nylon/PE | B | M | 1.2 | Cyan-0.7, | 110 |
| | | | | | white-1.5 | |
| CE132 | Nylon/PE | B | J | 1.2 | Cyan-0.7, | 145 |
| | | | | | white-1.5 | |
| E21 | Nylon/PE | B | K | 1.2 | Cyan-0.7, | 743 |
| | | | | | white-2.0 | |
| CE133 | Nylon/PE | B | L | 1.2 | Cyan-0.7, | 76 |
| | | | | | white-2.0 | |
| CE134 | Nylon/PE | B | M | 1.2 | Cyan-0.7, | 113 |
| | | | | | white-2.0 | |
| CE135 | Nylon/PE | B | J | 1.2 | Cyan-0.7, | 163 |
| | | | | | white-2.0 | |
| CE136 | Acrylic PET/ | K | — | 2.0 | 1.0 | 750 |
| | Foil/PE | | | | | |
| CE137 | Acrylic PET/ | L | — | 2.0 | 1.0 | 733 |
| | Foil/PE | | | | | |
| CE138 | Acrylic PET/ | M | — | 2.0 | 1.0 | 759 |
| | Foil/PE | | | | | |
| CE139 | Acrylic PET/ | J | — | 2.0 | 1.0 | 774 |
| | Foil/PE | | | | | |
| CE140 | Acrylic PET/ | K | — | 2.0 | 1.5 | 739 |
| | Foil/PE | | | | | |
| CE141 | Acrylic PET/ | L | — | 2.0 | 1.5 | 729 |
| | Foil/PE | | | | | |
| CE142 | Acrylic PET/ | M | — | 2.0 | 1.5 | 730 |
| | Foil/PE | | | | | |
| CE143 | Acrylic PET/ | J | — | 2.0 | 1.5 | 720 |
| | Foil/PE | | | | | |
| CE144 | Acrylic PET/ | K | — | 2.0 | 2.0 | 651 |
| | Foil/PE | | | | | |
| CE145 | Acrylic PET/ | L | — | 2.0 | 2.0 | 682 |
| | Foil/PE | | | | | |
| CE146 | Acrylic PET/ | M | — | 2.0 | 2.0 | 677 |
| | Foil/PE | | | | | |
| CE147 | Acrylic PET/ | J | — | 2.0 | 2.0 | 689 |
| | Foil/PE | | | | | |
| E22 | Acrylic PET/ | B | K | 2.0 | Cyan-0.7, | 978 |
| | Foil/PE | | | | white-1.0 | |
| CE148 | Acrylic PET/ | B | L | 2.0 | Cyan-0.7, | 57 |
| | Foil/PE | | | | white-1.0 | |
| CE149 | Acrylic PET/ | B | M | 2.0 | Cyan-0.7, | 430 |
| | Foil/PE | | | | white-1.0 | |
| CE150 | Acrylic PET/ | B | J | 2.0 | Cyan-0.7, | 201 |
| | Foil/PE | | | | white-1.0 | |
| E23 | Acrylic PET/ | B | K | 2.0 | Cyan-0.7, | 808 |
| | Foil/PE | | | | white-1.5 | |
| CE151 | Acrylic PET/ | B | L | 2.0 | Cyan-0.7, | 98 |
| | Foil/PE | | | | white-1.5 | |
| CE152 | Acrylic PET/ | B | M | 2.0 | Cyan-0.7, | 388 |
| | Foil/PE | | | | white-1.5 | |
| CE153 | Acrylic PET/ | B | J | 2.0 | Cyan-0.7, | 267 |
| | Foil/PE | | | | white-1.5 | |
| E24 | Acrylic PET/ | B | K | 2.0 | Cyan-0.7, | 870 |
| | Foil/PE | | | | white-2.0 | |
| CE154 | Acrylic PET/ | B | L | 2.0 | Cyan-0.7, | 43 |
| | Foil/PE | | | | white-2.0 | |
| CE155 | Acrylic PET/ | B | M | 2.0 | Cyan-0.7, | 390 |
| | Foil/PE | | | | white-2.0 | |
| CE156 | Acrylic PET/ | B | J | 2.0 | Cyan-0.7, | 233 |
| | Foil/PE | | | | white-2.0 | |
| CE157 | Corona PET/ | D | — | 1.2 | 1.0 | 790 |
| | Foil/PE | | | | | |
| CE158 | Corona PET/ | E | — | 1.2 | 1.0 | 560 |
| | Foil/PE | | | | | |
| CE159 | Corona PET/ | F | — | 1.2 | 1.0 | 755 |
| | Foil/PE | | | | | |
| CE160 | Corona PET/ | C | — | 1.2 | 1.0 | 610 |
| | Foil/PE | | | | | |
| CE161 | Corona PET/ | D | — | 1.2 | 1.5 | 629 |
| | Foil/PE | | | | | |
| CE162 | Corona PET/ | E | — | 1.2 | 1.5 | 522 |
| | Foil/PE | | | | | |
| CE163 | Corona PET/ | F | — | 1.2 | 1.5 | 730 |
| | Foil/PE | | | | | |
| CE164 | Corona PET/ | C | — | 1.2 | 1.5 | 737 |
| | Foil/PE | | | | | |
| CE165 | Corona PET/ | D | — | 1.2 | 2.0 | 711 |
| | Foil/PE | | | | | |
| CE166 | Corona PET/ | E | — | 1.2 | 2.0 | 591 |
| | Foil/PE | | | | | |
| CE167 | Corona PET/ | F | — | 1.2 | 2.0 | 716 |
| | Foil/PE | | | | | |
| CE168 | Corona PET/ | C | — | 1.2 | 2.0 | 639 |
| | Foil/PE | | | | | |
| E25 | Corona PET/ | A | D | 1.2 | Cyan-0.7, | 770 |
| | Foil/PE | | | | white-1.0 | |
| CE169 | Corona PET/ | A | E | 1.2 | Cyan-0.7, | 144 |
| | Foil/PE | | | | white-1.0 | |
| CE170 | Corona PET/ | A | F | 1.2 | Cyan-0.7, | 105 |
| | Foil/PE | | | | white-1.0 | |
| CE171 | Corona PET/ | A | C | 1.2 | Cyan-0.7, | 98 |
| | Foil/PE | | | | white-1.0 | |
| E26 | Corona PET/ | A | D | 1.2 | Cyan-0.7, | 750 |
| | Foil/PE | | | | white-1.5 | |
| CE172 | Corona PET/ | A | E | 1.2 | Cyan-0.7, | 70 |
| | Foil/PE | | | | white-1.5 | |
| CE173 | Corona PET/ | A | F | 1.2 | Cyan-0.7, | 116 |
| | Foil/PE | | | | white-1.5 | |
| CE174 | Corona PET/ | A | C | 1.2 | Cyan-0.7, | 134 |
| | Foil/PE | | | | white-1.5 | |
| E27 | Corona PET/ | A | D | 1.2 | Cyan-0.7, | 688 |
| | Foil/PE | | | | white-2.0 | |
| CE175 | Corona PET/ | A | E | 1.2 | Cyan-0.7, | 92 |
| | Foil/PE | | | | white-2.0 | |
| CE176 | Corona PET/ | A | F | 1.2 | Cyan-0.7, | 105 |
| | Foil/PE | | | | white-2.0 | |
| CE177 | Corona PET/ | A | C | 1.2 | Cyan-0.7, | 101 |
| | Foil/PE | | | | white-2.0 | |

The testing results in Table 2 demonstrate that the unexpectedly large improvement in laminate bond strength when the second print layer includes (a) an uncrosslinked polyurethane comprising a member selected from the group consisting of polyester segments and polyether segments; (b) a pigment; and (c) an aminosilane compound comprising at least one member selected from the group consisting of primary amino groups and secondary amino groups are obtained at all coating weights tested for the second print layer. While the comparative examples made with only the white print layer had similar bond strengths whether the print layer contained no silane or any one of the silane compounds tested, with a slight decrease in bond strength with increasing coating weight of the print layer, when two print layers were tested the bond strengths were much higher for the Examples of the Invention E16-E27 than for the Comparative Examples CE106-CE114, CE127-CE135, CE148-CE156, and CE169-CE177.

Table 3 gives bond strengths for Examples of the Invention (E) and Comparative Examples (CE) in which different silane concentrations were used in the white ink layers.

TABLE 3
EFFECTS OF DIFFERENT SILANE WEIGHTS

| | Designation | Ink | Ink | Ad- | Ink | |
|---|---|---|---|---|---|---|
| | for | used | used | hesive | Layer | |
| | Primary & | for | for | Weight | Coating | |
| | Secondary | First | Second | (pounds | Weights | Bond |
| | Films | Ink | Ink | per | (pounds | Strength |
| | and Adhesive | Layer | Layer | ream) | per ream) | (g/in²) |
| CE178 | Corona PET/PE | J | — | 1.5 | 1.2 | 334 |
| CE179 | Corona PET/PE | N | — | 1.5 | 1.2 | 329 |
| CE180 | Corona PET/PE | K | — | 1.5 | 1.2 | 325 |
| CE181 | Corona PET/PE | O | — | 1.5 | 1.2 | 301 |
| CE182 | Corona PET/PE | P | — | 1.5 | 1.2 | viscosity |
| | | | | | | too thick |
| | | | | | | to test |
| CE179 | Corona PET/PE | B | J | 1.5 | Cyan-0.7, | 261 |
| | | | | | white-1.2 | |
| E28 | Corona PET/PE | B | N | 1.5 | Cyan-0.7, | 646 |
| | | | | | white-1.2 | |
| E29 | Corona PET/PE | B | K | 1.5 | Cyan-0.7, | 690 |
| | | | | | white-1.2 | |
| E30 | Corona PET/PE | B | O | 1.5 | Cyan-0.7, | 740 |
| | | | | | white-1.2 | |
| E31 | Corona PET/PE | B | P | 1.5 | Cyan-0.7, | viscosity |
| | | | | | white-1.2 | too thick |
| | | | | | | to test |
| CE183 | Nylon/PE | J | — | 1.5 | 1.2 | 788 |
| CE184 | Nylon/PE | N | — | 1.5 | 1.2 | 754 |
| CE185 | Nylon/PE | K | — | 1.5 | 1.2 | 720 |
| CE186 | Nylon/PE | O | — | 1.5 | 1.2 | 689 |
| CE187 | Nylon/PE | P | — | 1.5 | 1.2 | viscosity |
| | | | | | | too thick |
| | | | | | | to test |
| CE188 | Nylon/PE | B | J | 1.5 | Cyan-0.7, | 110 |
| | | | | | white-1.2 | |
| E32 | Nylon/PE | B | N | 1.5 | Cyan-0.7, | 635 |
| | | | | | white-1.2 | |
| E33 | Nylon/PE | B | K | 1.5 | Cyan-0.7, | 670 |
| | | | | | white-1.2 | |
| E34 | Nylon/PE | B | O | 1.5 | Cyan-0.7, | 792 |
| | | | | | white-1.2 | |
| E35 | Nylon/PE | B | P | 1.5 | Cyan-0.7, | viscosity |
| | | | | | white-1.2 | too thick |
| | | | | | | to test |

The testing results in Table 3 demonstrate that while the amount of silane had little effect on bond strength for a laminate made with only one print layer, laminates made with two print layers had a substantial increase in bond strength even for the lowest level of the aminosilane compound that was tested.

In the foregoing testing better ink lay and opacity were noticeable in the Examples of the Invention. The second print layer according to the invention appeared to prevent re-wetting of the first print layer and also to prevent solvent-based adhesive from biting into the second print layer.

The description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A laminate packaging material, comprising a first film; a first print layer on an inside surface of the first film; a second print layer on a side of the first print layer opposite the first film; an adhesive layer on a side of the second print layer opposite the first print layer, and a second film over the adhesive layer,
wherein the second print layer comprises (a) an uncrosslinked polyurethane comprising a member selected from the group consisting of polyester segments and polyether segments; (b) a pigment; and (c) an aminosilane compound comprising at least one member selected from the group consisting of primary amino groups and secondary amino groups.

2. A laminate packaging material according to claim 1, wherein the aminosilane compound comprises at least two members selected from the group consisting of primary amino groups and secondary amino groups.

3. A laminate packaging material according to claim 1, wherein the aminosilane compound is N[3-(trimethoxysilyl)propyl]ethylenediamine.

4. A laminate packaging material according to claim 1, wherein the second print layer is a coating layer.

5. A laminate packaging material according to claim 1, wherein the uncrosslinked polyurethane comprises an uncrosslinked aliphatic poly(urethane/urea).

6. A laminate packaging material according to claim 1, wherein the second print layer comprises from about 0.2 up to about 2.0 wt. % of the aminosilane compound.

7. A laminate packaging material according to claim 6, wherein the aminosilane compound is N[3-(trimethoxysilyl)propyl]ethylenediamine.

8. A laminate packaging material according to claim 1, wherein the second print layer further comprises acetyl tributyl citrate.

9. A laminate packaging material according to claim 1, wherein the first print layer comprises an uncrosslinked polyurethane comprising a member selected from the group consisting of polyester segments and polyether segments.

10. A laminate packaging material according to claim 9, wherein the uncrosslinked polyurethane comprising a member selected from the group consisting of polyester segments and polyether segments of the first print layer is the same as the uncrosslinked polyurethane comprising a member selected from the group consisting of polyester segments and polyether segments of the second print layer.

11. A container formed from the laminate packaging material of claim 1.

12. A method of improving bond strength in a laminate comprising a primary film, a first print layer on the primary film, a second print layer on the first print layer, an adhesive layer on the second print layer, and a second film on the adhesive layer, the method comprising including in the second print layer (a) an uncrosslinked polyurethane comprising a member selected from the group consisting of polyester segments and polyether segments; (b) a pigment; and (c) an aminosilane compound comprising at least one member selected from the group consisting of primary amino groups and secondary amino groups.

13. A method according to claim 12, wherein the aminosilane compound is N-[3-(trimethoxysilyl)propyl]ethylenediamine.

14. A method according to claim 12, wherein the second print layer is a coating layer.

15. A method according to claim 12, wherein the uncrosslinked polyurethane comprises an uncrosslinked aliphatic poly(urethane/urea).

16. A method according to claim 12, wherein the second print layer comprises from about 0.2 up to about 2.0 wt. % of the aminosilane compound.

17. A method of making a package or container, comprising:
preparing a laminate comprising a first film, a first print layer printed on the first film, a second print layer printed on the second print layer, and an adhesive layer applied over the second print layer, wherein a second film is adhered by the adhesive layer such that the first print layer and the second print layer lie between the first film and the second film, wherein the second print layer comprises (a) an uncrosslinked polyurethane comprising a member selected from the group consisting of polyester segments and polyether segments; (b) a pigment; and (c) an aminosilane compound comprising at least one member selected from the group consisting of primary amino groups and secondary amino groups; and
forming the laminate into the package or container.

18. A method according to claim 17, wherein the first print layer comprises a process-color print.

19. A method according to claim 17, wherein the first print layer comprises an uncrosslinked polyurethane comprising a member selected from the group consisting of polyester segments and polyether segments.

20. A package or container made according to the method of claim 17.
